(19) United States
(12) Patent Application Publication
(10) Pub. No.: US 2011/0223475 A1
(43) Pub. Date: Sep. 15, 2011

(54) SEAL STRUCTURE AND ASSOCIATED METHOD

(75) Inventors: Digamber Gurudas Porob, Bangalore (IN); Dong-Sil Park, Niskayuna, NY (US); Sundeep Kumar, Bangalore (IN); Atanu Saha, Bangalore (IN)

(73) Assignee: GENERAL ELECTRIC COMPANY, SCHENECTADY, NY (US)

(21) Appl. No.: 12/720,874

(22) Filed: Mar. 10, 2010

(51) Int. Cl. H01M 2/08; B32B 38/00

(52) U.S. Cl. 429/185; 156/280

(57) ABSTRACT

A seal structure is provided for an energy storage device. The seal structure includes a sealing glass joining an ion-conducting first ceramic to an electrically insulating second ceramic, wherein the ion-conducting first ceramic has an anode surface defining an anode compartment and a cathode surface defining a cathode compartment, wherein the sealing glass has an exposed portion, wherein the exposed portion is open to one or more of the anode compartment and the cathode compartment, wherein the exposed portion of the sealing glass is coated with a coating composition comprising one or more of boria, alumina, titania, zirconia, yttria, and ceria. Methods for forming the seal structure and article made therefrom are also provided.

### BACKGROUND

1. Technical Field

The invention includes embodiments that relate to a seal structure for an energy storage device. The invention includes embodiments that relate to a sealing material to be used in the seal structure of an energy storage device. The invention includes embodiments that relate to a method of sealing an energy storage device.

2. Discussion of Related Art

Development work has been undertaken on high temperature rechargeable batteries using sodium for the negative electrode. The liquid sodium negative electrode is separated from a positive electrode by a sodium-ion conducting solid electrolyte. Suitable material includes beta-alumina and beta”-alumina, known together as beta-alumina solid electrolyte (BASE), which is used as the separator of electrodes. Some electrochemical cells have a metallic casing. The ceramic parts of the cell can be joined or bonded via a sealing material. The sealing material may include a glassy material having undesirable characteristics associated with its use. Bonded ceramic parts formed from dissimilar materials in a high temperature cell may crack due to thermal stress caused by mismatch in the coefficient of thermal expansion. The coefficient of thermal expansion for two ceramic parts can be substantially dissimilar. The sealing material may have a limited life, and bond failure or degradation may cause cell failure due to a direct conduction path between the cathode and anode electrodes.

It may be desirable to have a sealing material for an energy storage device that differs from those sealing materials that are currently available. It may be desirable to have a seal structure that differs from those seal structures that are currently available. It may be desirable to have a method of sealing an energy storage device that differs from those methods that are currently available.

### BRIEF DESCRIPTION

In accordance with an embodiment of the invention, a seal structure is provided for an energy storage device. The seal structure comprises a sealing glass joining an ion-conducting first ceramic to an electrically insulating second ceramic, wherein the ion-conducting first ceramic has an anode surface defining an anode compartment and a cathode surface defining a cathode compartment, wherein the sealing glass has an exposed portion, wherein the exposed portion is open to one or more of the anode compartment and the cathode compartment, wherein the exposed portion of the sealing glass is coated with a coating composition comprising one or more of boria, alumina, titania, zirconia, yttria, and ceria.

In accordance with an embodiment of the invention, a process is provided that is capable of forming a seal structure for an energy storage device. The process comprises placing a sealing glass at the joint of an ion conducting first ceramic and an electrically insulating second ceramic, wherein the ion-conducting separator has an anode surface defining an anode compartment and a cathode surface defining a cathode compartment, wherein the sealing glass has an exposed portion, wherein the exposed portion is open to one or more of the anode compartment and the cathode compartment, forming an assembly comprising the ion conducting first ceramic, the electrically insulating second ceramic, and the sealing glass, heating the assembly to a processing temperature of the sealing glass, applying a coating composition over at least one exposed portion of the sealing glass, sintering the assembly at a sintering temperature to form a seal structure.

In accordance with an embodiment of the invention, an article is provided that includes a seal structure for use in an energy storage device. The article comprises a seal structure comprising a sealing glass, wherein the sealing glass joins an ion-conducting first ceramic to an electrically insulating second ceramic; wherein the ion-conducting separator has an anode surface defining an anode compartment and a cathode surface defining a cathode compartment, wherein the sealing glass has an exposed portion, wherein the exposed portion is open to one or more of the anode compartment and the cathode compartment; wherein the exposed portion of the sealing glass is coated with a coating composition comprising one or more of boria, alumina, titania, zirconia, yttria, and ceria.

### BRIEF DESCRIPTION OF DRAWINGS

FIG. 1 is a schematic view showing a seal structure in accordance with one embodiment of the invention.

FIG. 2 is a schematic view showing a seal structure in accordance with one embodiment of the invention.

FIG. 3 is a schematic view showing a seal structure in accordance with one embodiment of the invention.

FIG. 4 is a schematic view showing a process of forming a seal structure in accordance with one embodiment of the invention.

FIG. 5 is a schematic view showing a process of forming a seal structure in accordance with one embodiment of the invention.

FIG. 6 is a pictorial view showing effects of corrosion on coated and uncoated sealing material in accordance with one embodiment of the invention.

### DETAILED DESCRIPTION

The invention includes embodiments that relate to a seal structure for an energy storage device. The invention includes embodiments that relate to a sealing material for an energy storage device. The invention includes embodiments that relate to a method of sealing an electrochemical cell.

With the advent of high temperature rechargeable cells generally utilizing corrosive components as anodic material, for example, sodium, and cathodic material, for example, metal halides or metal sulfides, hermeticity of the cell seals has become increasingly important. The seals are typically used to seal the beta-alumina ion-conducting solid electrolyte and the alpha-alumina collar resulting in the formation of an anode compartment and a cathode compartment that are isolated from each other. Of the hermetic seals utilized in high temperature rechargeable cells, one of the most reliable seals is the glass-metal seal comprising an outer metal eyelet surrounding a central metal rod or tube and sealed thereto by a glass member. The central metal rod or tube known as the feedthrough generally functions as a terminal for the cell with the outer metal eyelet being of opposite polarity with the glass member therebetween providing the necessary electrical insulation.

Other, commercially available glass-metal seals such as those used in electrical components are generally comprised of steel outer metal eyelets and borosilicate glass sealing members. Such glass-metal seals, while relatively inexpensive, have not generally been used in sealing high temperature rechargeable electrochemical cells since the components of such cells are chemically reactive with the glass-metal seals. Accordingly, glass-metal seals for high temperature rechargeable electrochemical cells have required the use of metals such as corrosion resistant titanium, tantalum, molybdenum and the like as the feedthrough for such seals. However, the use of such metals has escalated the cost of the cells because of the high cost of such metals and the high cost of working such metals into an acceptable glass-metal seal. As a result, glass-metal seals for non-aqueous cells generally comprise the most expensive part of the cell packaging. More recently, various efforts have been made for finding new glass compositions to be used as the sealing glass material while at the same time avoiding the use of feedthroughs. While selecting the sealing glass material, care needs to be taken that the glass composition resists corrosion both form the anodic material and from the cathodic material, and also has a coefficient of thermal expansion that matches the components to be sealed to avoid deterioration and damage due to thermal stresses. The glass composition is tuned to render it less corrosive to the anodic and cathodic materials, thus avoiding or minimizing corrosion.

Embodiments of the invention as described herein address the noted shortcomings of the art. The seal structure described herein fills the needs described above by providing an improved corrosion resistance. These electrochemical cells could potentially offer improved lifetime and cost, demanded by the recent rapid development of a variety of equipments known in the art. As discussed above, seals that are currently used in sealing are subject to corrosion resulting in untimely cell failure. As discussed above, the seal structure disclosed herein comprises a sealing glass joining an ion-conducting first ceramic to an electrically insulating second ceramic. Joining the first ceramic and the second ceramic with the sealing glass results in the isolation of the anode compartment and the cathode compartment. The seal structure disclosed herein is formed by coating the exposed portions of the sealing glass, that may come in contact with one or more of the anodic material and the cathodic material, as the sealing glass may be open to one or more of the anode compartment and the cathode compartment. In one embodiment, the sealing glass is coated on all exposed portions. In one embodiment, the sealing glass is coated on the side exposed to the anode compartment. In one embodiment, the sealing glass is coated on the side exposed to the cathode compartment.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Moreover, the use of “top,” “bottom,” “above,” “below,” and variations of these terms is made for convenience, but does not require any particular orientation of the components unless otherwise stated. Approximating language, as used herein throughout the specification and claims, may be applied to modify any quantitative representation that could permissibly vary without resulting in a change in the basic function to which it may be about related. Accordingly, a value modified by a term such as “about” is not limited to the precise value specified. In some instances, the approximating language may correspond to the precision of an instrument for measuring the value.

As used herein, cathodic material is the material that supplies electrons during charge and is present as part of a redox reaction. Anodic material accepts electrons during charge and is present as part of the redox reaction.

In accordance with an embodiment of the invention, a seal structure is provided for an energy storage device. The seal structure comprises a sealing glass joining an ion-conducting first ceramic to an electrically insulating second ceramic, wherein the ion-conducting separator has an anode surface defining an anode compartment and a cathode surface defining a cathode compartment. The sealing glass has an exposed portion, wherein the exposed portion is open to one or more of the anode compartment and the cathode compartment. The exposed portion of the sealing glass is coated with a coating composition, wherein the coating composition comprises one or more of boria, alumina, titania, zirconia, yttria, and ceria. The seal structure of the present invention makes it possible to construct a high temperature rechargeable electrochemical cell with a long lifetime.

In one embodiment, the ion-conducting first ceramic is beta-alumina. In one embodiment, the electrically insulating second ceramic is alpha-alumina. In various embodiments, the coating on the glass seal on either side stays as an amorphous or a crystalline layer and acts as a barrier to the corrosion caused by the cathodic material, for example metal halide or the anodic material, for example sodium.

In one embodiment, the exposed portion of the sealing glass may be open both to the anode compartment and to the cathode compartment and the exposed portions are coated with the coating composition. In embodiments where the sealing glass open to both the anode and the cathode compartment are coated, the sealing glass may comprise any suitable material known to one skilled in the art and used in the sealing of an ion-conducting first ceramic to an electrically insulating second ceramic. In one embodiment, where the sealing glass open to both the anode and the cathode compartment are coated, the sealing glass may comprise about 35 weight percent to about 15 weight percent of silica, about 40 weight percent to about 25 weight percent of boria, about 1 weight percent to about 10 weight percent of alumina and about 10 weight percent to about 25 weight percent of sodium oxide. Other considerations, such as working temperature, glass transition temperature and thermal expansion coefficient may be taken into account for sealing glass selection. In one embodiment, where the sealing glass open to both the anode and the cathode compartment are coated, the sealing glass may comprise about 32 weight percent of silica, about 40 weight percent of boria, about 8 weight percent of alumina and about 20 weight percent of sodium oxide.

In one embodiment, where the sealing glass open to both the anode and the cathode compartment is coated, the sealing glass has a thermal expansion coefficient in a range of from about 4 parts per million per degrees Centigrade to about 8 parts per million per degrees Centigrade. In another embodiment, the sealing glass has a thermal expansion coefficient in a range of from about 4.5 parts per million per degrees Centigrade to about 7.5 parts per million per degrees Centigrade. In yet another embodiment, the sealing glass has a thermal expansion coefficient in a range of from about 5 parts per million per degrees Centigrade to about 6 parts per million per degrees Centigrade.

In one embodiment, the coating composition is applied on the exposed portions open to the anode compartment and open to the cathode compartment, wherein the coating composition resists corrosion or degradation by contact with sodium or metal halides at a working temperature. In one embodiment, the coating composition applied to the exposed portion open to the anode compartment comprises one or more of boria, alumina, titania, and ceria. In one embodiment, the coating composition applied to the exposed portion open to the anode compartment comprises alumina. In one embodiment, the coating composition applied to the exposed portion open to the anode compartment comprises boria.

In one embodiment, the coating composition applied to the exposed portion open to the anode compartment has a thermal expansion coefficient in a range of from about 3 parts per million per degrees Centigrade to about 15 parts per million per degrees Centigrade. In another embodiment, the coating composition applied to the exposed portion open to the anode compartment has a thermal expansion coefficient in a range of from about 4 parts per million per degrees Centigrade to about 12 parts per million per degrees Centigrade. In yet another one embodiment, the coating composition applied to the exposed portion open to the anode compartment has a thermal expansion coefficient in a range of from about 5 parts per million per degrees Centigrade to about 10 parts per million per degrees Centigrade.

In one embodiment, the coating composition applied to the exposed portion open to the cathode compartment comprises one or more of zirconia, yttria, alumina, titania, and ceria. In one embodiment, the coating composition applied to the exposed portion open to the cathode compartment comprises zirconia. In one embodiment, the coating composition applied to the exposed portion open to the cathode compartment comprises and yttria stabilized zirconia.

In one embodiment, the coating composition applied to the exposed portion open to the cathode compartment has a thermal expansion coefficient in a range of from about 3 parts per million per degrees Centigrade to about 15 parts per million per degrees Centigrade. In another embodiment, the coating composition applied to the exposed portion open to the anode compartment has a thermal expansion coefficient in a range of from about 4 parts per million per degrees Centigrade to about 12 parts per million per degrees Centigrade. In yet another one embodiment, the coating composition applied to the exposed portion open to the anode compartment has a thermal expansion coefficient in a range of from about 5 parts per million per degrees Centigrade to about 10 parts per million per degrees Centigrade.

In one embodiment, the exposed portion of the sealing glass open to the anode compartment is coated with the coating composition and the exposed portion open to the cathode compartment is left uncoated, wherein the coating composition resists corrosion or degradation by contact with sodium at a working temperature, and wherein the sealing glass resists corrosion or degradation by contact with metal halides at a working temperature. In embodiments where the sealing glass open to the anode is coated, the sealing glass may comprise any suitable material known to one skilled in the art which is resistant to metal halides or metal sulfides and used in the sealing of an ion-conducting first ceramic to an electrically insulating second ceramic. In embodiments where the sealing glass is open to the cathode compartment, the sealing glass may comprise about 1 weight percent to about 15 weight percent of silica, about 30 weight percent to about 55 weight percent of boria, about 10 weight percent to about 25 weight percent of alumina, about 1 weight percent to about 15 weight percent calcium oxide, about 5 weight percent to about 20 weight percent of strontium oxide and about 5 weight percent to about 20 weight percent of barium oxide. In one embodiment, where the sealing glass is open to the cathode compartment, the sealing glass comprises about 8 weight percent of silica, about 45 weight percent of boria, about 19 weight percent of alumina, about 6 weight percent of calcium oxide, about 12 weight percent of strontium oxide and about 10 weight percent of barium oxide.

As discussed above, in one embodiment, the coating composition applied to the exposed portion open to the anode compartment comprises one or more of boria, alumina, titania, and ceria. In one embodiment, the coating composition applied to the exposed portion open to the anode compartment comprises alumina. In one embodiment, the coating composition applied to the exposed portion open to the anode compartment comprises boria.

In one embodiment, the exposed portion of the sealing glass open to the cathode compartment is coated with the coating composition and the exposed portion open to the anode compartment is left uncoated, wherein the coating composition resists corrosion or degradation by contact with metal halides at a working temperature, and wherein the sealing glass resists corrosion or degradation by contact with sodium at a working temperature. In embodiments where the sealing glass open to the cathode compartment are coated, the sealing glass may comprise any suitable material known to one skilled in the art which is resistant to sodium and used in the sealing of an ion-conducting first ceramic to an electrically insulating second ceramic. In embodiments where the sealing glass is open to the anode compartment, the sealing glass may comprise about 50 weight percent to about 75 weight percent of silica, about 10 weight percent to about 20 weight percent of boria, about 5 weight percent to about 25 weight percent of alumina, and about 1 weight percent to about 5 weight percent of zinc oxide. In one embodiment, where the sealing glass is open to the anode compartment, the sealing glass comprises about 68 weight percent of silica, about 17 weight percent of boria, about 12 weight percent of alumina, and about 1 weight percent of zinc oxide.

As discussed above, in one embodiment, the coating composition applied to the exposed portion open to the cathode compartment comprises one or more of zirconia, yttria, alumina, titania, and ceria. In one embodiment, the coating composition applied to the exposed portion open to the cathode compartment comprises zirconia. In one embodiment, the coating composition applied to the exposed portion open to the cathode compartment comprises yttria stabilized zirconia.

In one embodiment, the sealing glass can seal the ion-conducting first ceramic having a first thermal expansion coefficient and the electrically insulating second ceramic having a second thermal expansion coefficient that is different from the first thermal expansion coefficient. In one embodiment, the thermal expansion coefficient of the sealing glass is about the same as a thermal expansion coefficient of the ion-conducting first ceramic. In one embodiment, the thermal expansion coefficient of the sealing glass is about the same as a thermal expansion coefficient of the electrically insulating second ceramic.

In one embodiment, the sealing glass has a processing temperature of greater than about 850 degrees Centigrade. In another embodiment, the sealing glass has a processing temperature of greater than about 850 degrees Centigrade to less than about 1000 degrees Centigrade.

In one embodiment, the coating composition has a processing temperature of greater than about 850 degrees Centigrade. In another embodiment, the coating composition has a processing temperature of greater than about 850 degrees Centigrade to less than about 1000 degrees Centigrade.

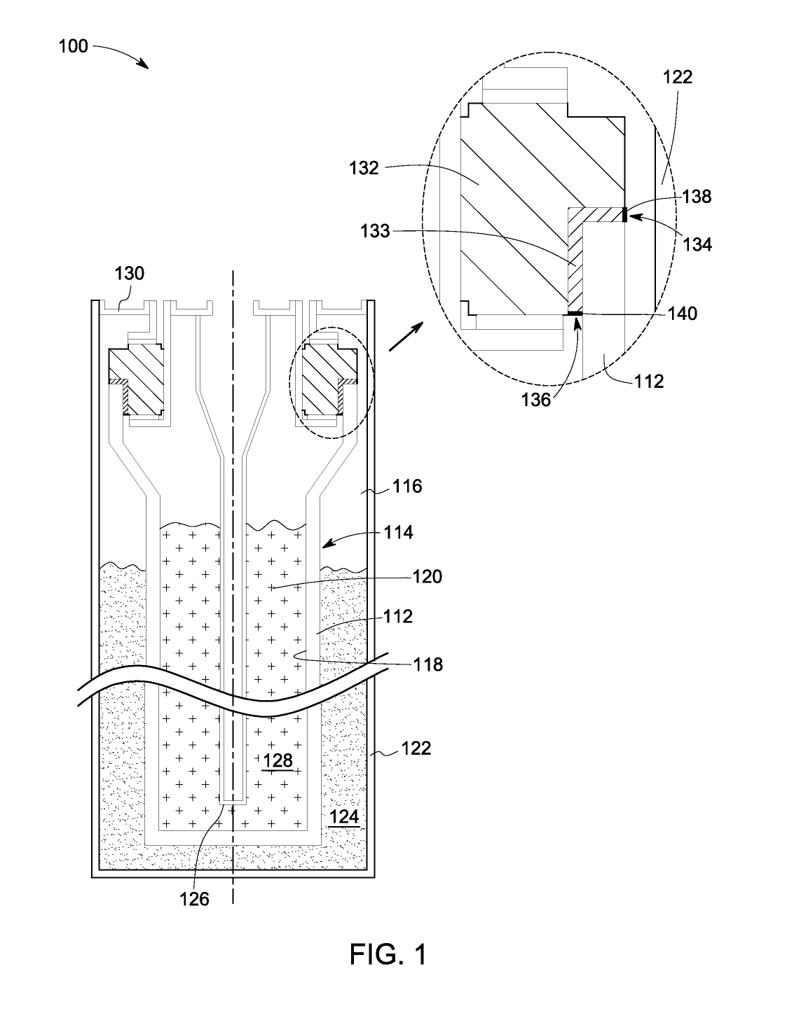

Referring to FIG. 1, a schematic view showing a cross section of one embodiment of a seal structure 100 in accordance with the present invention is provided. FIG. 1 includes a beta-alumina tube 112 functioning as the ion-conducting first ceramic. The beta-alumina tube 112 has an anode surface 114 defining an anode compartment 116 and a cathode surface 118 defining a cathode compartment 120. The structure includes an outer metal container 122 functioning as a negative terminal for sodium 124 an anode material in anode compartment 116, a metal rod functioning as a current collector 126, the metal rod surrounded by a cathode 128, a positive electrode material infused with molten halide contained in the cathode compartment 120, a metal cap 130, and an alpha-alumina collar 132 functioning as the electrically insulating second ceramic. A sealing glass 133 is placed between the beta-alumina tube 112 and the alpha-alumina collar 132. The sealing glass is open at location 134 to the anode compartment 116 and is open at location 136 to the cathode compartment 120. As discussed above, the sealing glass 133 may comprise any suitable material known to one skilled in the art and used in the sealing of an ion-conducting first ceramic 112 to an electrically insulating second ceramic 132. In one embodiment, the sealing glass 133 may comprise about 32 weight percent of silica, about 40 weight percent of boria, about 8 weight percent of alumina and about 20 weight percent of sodium oxide. The sealing glass is coated with a coating composition 138 at location 134 open to the anode compartment 116 and is coated with a coating composition 140 at location 136 open to the cathode compartment 120. In one embodiment, the coating composition 138 applied at location 134 open to the anode compartment 116 comprises one or more of boria, alumina, titania, and ceria. In one embodiment, the coating composition applied 140 applied at location 136 open to the cathode compartment 120 comprises one or more of zirconia, yttria, alumina, titania, and ceria.

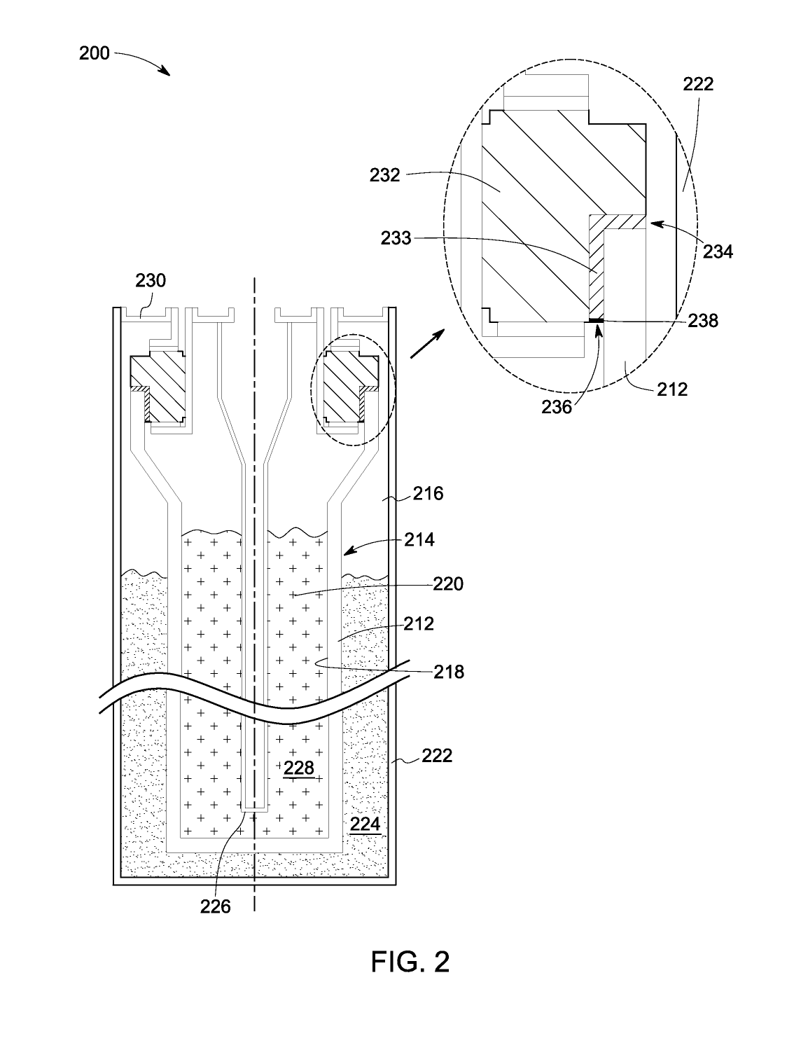

Referring to FIG. 2 a schematic view showing a cross section of one embodiment of a seal structure 200 in accordance with the present invention is provided. FIG. 2 includes a beta-alumina tube 212 functioning as the ion-conducting first ceramic. The beta-alumina tube 212 has an anode surface 214 defining an anode compartment 216 and a cathode surface 218 defining a cathode compartment 220. The structure includes an outer metal container 222 functioning as a negative terminal for sodium 224 an anode material in anode compartment 216, a metal rod functioning as a current collector 226, the metal rod surrounded by a cathode 228, a positive electrode material infused with molten halide contained in the cathode compartment 220, a metal cap 230, and an alpha-alumina collar 232 functioning as the electrically insulating second ceramic. A sealing glass 233 is placed between the beta-alumina tube 212 and the alpha-alumina collar 232. The sealing glass is open at location 234 to the anode compartment 216 and is open at location 236 to the cathode compartment 220. As discussed above, the sealing glass 233 in one embodiment, may comprise about 68 weight percent of silica, about 17 weight percent of boria, about 12 weight percent of alumina, and about 1 weight percent of zinc oxide. The sealing glass is coated with a coating composition 238 at location 236 open to the cathode compartment 220 and is left uncoated at location 234, which is open to the anode compartment 216. In one embodiment, the coating composition 238 applied at location 236 open to the cathode compartment 220 comprises one or more of zirconia, yttria, alumina, titania, and ceria.

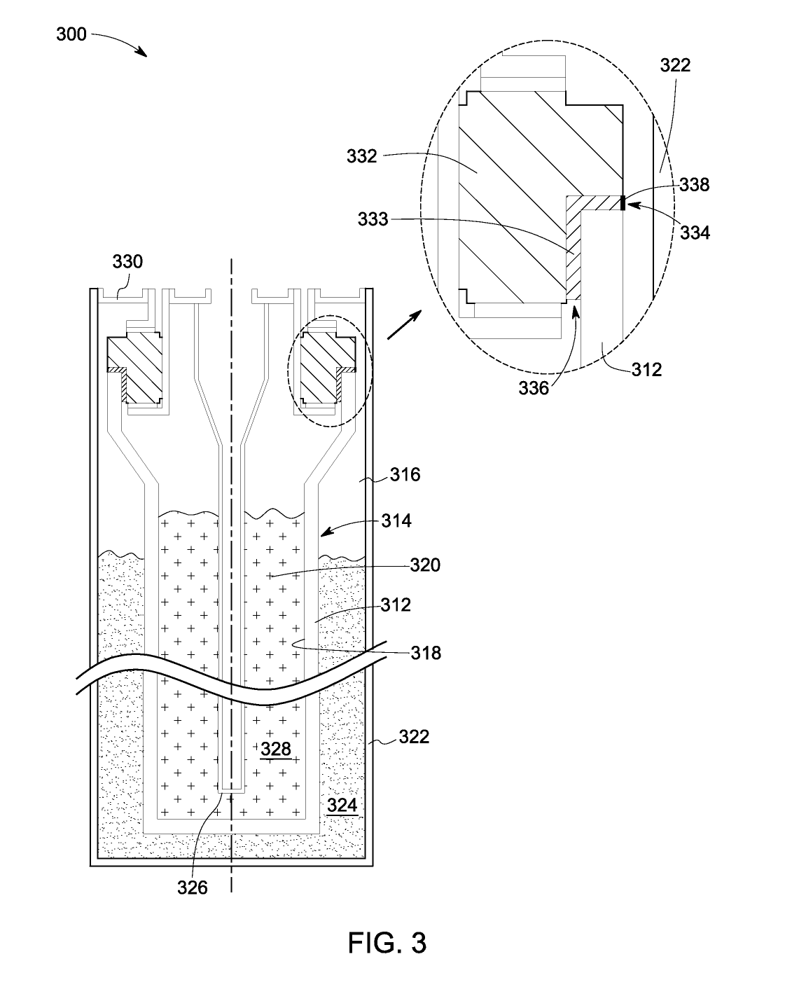

Referring to FIG. 3 a schematic view showing a cross section of one embodiment of a seal structure 300 in accordance with the present invention is provided. FIG. 3 includes a beta-alumina tube 312 functioning as the ion-conducting first ceramic. The beta-alumina tube 312 has an anode surface 314 defining an anode compartment 316 and a cathode surface 318 defining a cathode compartment 320. The structure includes an outer metal container 322 functioning as a negative terminal for sodium 324 an anode material in anode compartment 316, a metal rod functioning as a current collector 326, the metal rod surrounded by a cathode 328, a positive electrode material infused with molten halide contained in the cathode compartment 320, a metal cap 330, and an alpha-alumina collar 332 functioning as the electrically insulating second ceramic. A sealing glass 333 is placed between the beta-alumina tube 312 and the alpha-alumina collar 332. The sealing glass is open at location 334 to the anode compartment 316 and is open at location 336 to the cathode compartment 320. As discussed above, the sealing glass 333 in one embodiment may comprise about 8 weight percent of silica, about 45 weight percent of boria, about 19 weight percent of alumina, about 6 weight percent of calcium oxide, about 12 weight percent of strontium oxide and about 10 weight percent of barium oxide. The sealing glass is coated with a coating composition 238 at location 234 open to the anode compartment 216 and is left uncoated at location 236 which is open to the cathode compartment 220. In one embodiment, the coating composition 238 applied at location 234 open to the anode compartment 216 comprises one or more of boria, alumina, titania, and ceria.

In one embodiment, the above cell is a sodium-metal halide cell. The process for manufacturing the above described cell generally includes the steps of: bonding the open end periphery of the beta-alumina tube with the electrically insulating second ceramic in the form of an insulator ring made of alpha-alumina by means of the fully or partially coated sealing glass compositions, bonding the insulator ring supporting the beta-alumina tube with the metal containers functioning as the anode and the cathode by a solid phase reaction or the like at a high temperature under pressure, supplying the sodium and the metal halides into the anode compartment and the cathode compartment respectively, and hermetically closing the metal containers with the metal lids by means of welding to provide a cell.

In accordance with an embodiment of the invention, a process is provided that is capable of forming a seal structure for an energy storage device. The process comprises placing a sealing glass at the joint of an ion conducting first ceramic and an electrically insulating second ceramic, wherein the ion-conducting separator has an anode surface defining an anode compartment and a cathode surface defining a cathode compartment, wherein the sealing glass has an exposed portion, wherein the exposed portion is open to one or more of the anode compartment and the cathode compartment, forming an assembly comprising the ion conducting first ceramic, the electrically insulating second ceramic, and the sealing glass, heating the assembly to a processing temperature of the sealing glass, applying a coating composition over at least one exposed portion of the sealing glass, sintering the assembly at a sintering temperature to form a seal structure. In an alternative embodiment, the coating composition may be applied before heating the assembly to a processing temperature, and the assembly sintered at sintering temperatures to form the seal structure.

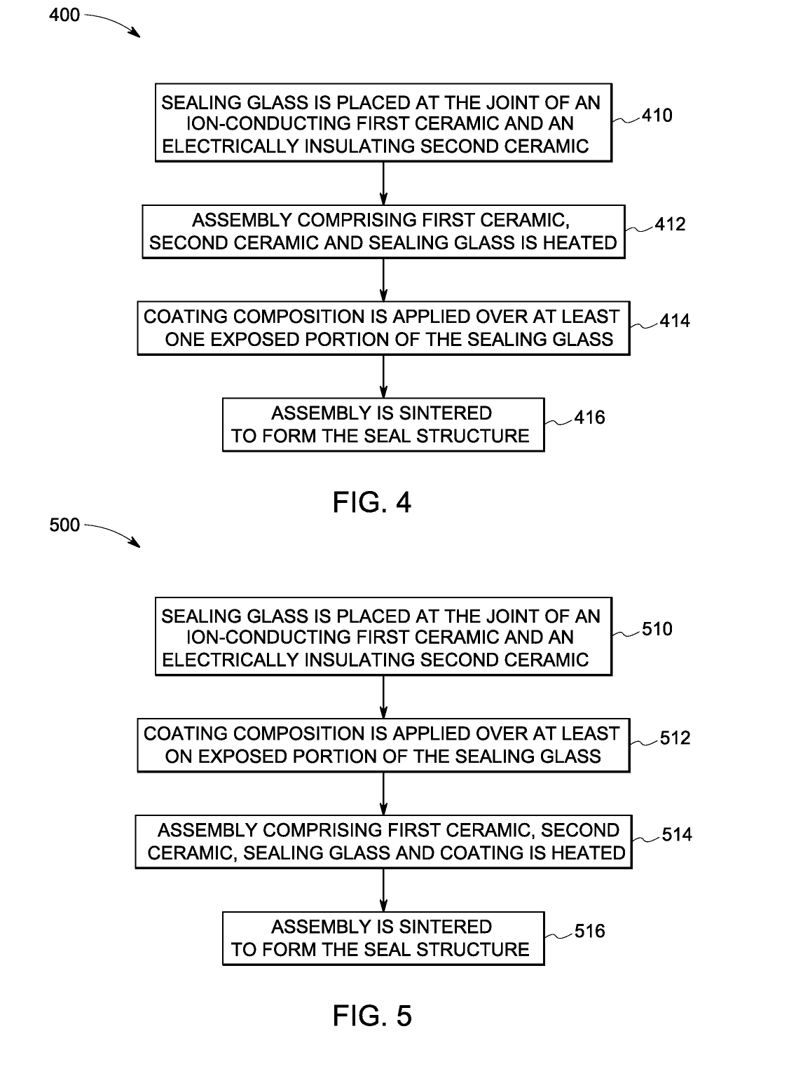

Referring to FIG. 4, a stepwise method 400 of forming the seal structure in accordance with one embodiment of the invention is provided. In a first step 410 a sealing glass is placed at the joint of an ion conducting first ceramic and an electrically insulating second ceramic. The sealing glass has an exposed portion, wherein the exposed portion is open to one or more of an anode compartment and a cathode compartment. The anode compartment and the cathode compartment are isolated when the ion conducting first ceramic and an electrically insulating second ceramic are joined together. In a second step 412, the assembly comprising the ion conducting first ceramic, the electrically insulating second ceramic, and the sealing glass is heated to a processing temperature of the sealing glass. In a third step 414, a coating composition is applied over at least one exposed portion of the sealing glass. In a fourth step 416, the assembly is sintered at a sintering temperature to form the seal structure.

Referring to FIG. 5, a stepwise method 500 of forming the seal structure in accordance with one embodiment of the invention is provided. In a first step 510 a sealing glass is placed at the joint of an ion conducting first ceramic and an electrically insulating second ceramic. The sealing glass has an exposed portion, wherein the exposed portion is open to one or more of an anode compartment and a cathode compartment. The anode compartment and the cathode compartment are isolated when the ion conducting first ceramic and an electrically insulating second ceramic are joined together. In a second step 512, a coating composition is applied over at least one exposed portion of the sealing glass. In a third step 514, the assembly comprising the ion conducting first ceramic, the electrically insulating second ceramic, the sealing glass, and the coating composition, is heated to a processing temperature of the sealing glass. In a fourth step 516, the assembly is sintered at a sintering temperature to form the seal structure.

In one embodiment, the sintering temperature is in a range of from about 400 degrees Centigrade to about 1600 degrees Centigrade. In another embodiment, the sintering temperature is in a range of from about 500 degrees Centigrade to about 1500 degrees Centigrade. In yet another embodiment, the sintering temperature is in a range of from about 600 degrees Centigrade to about 1400 degrees Centigrade.

In one embodiment, the processing temperature is greater than about 850 degrees Centigrade. In another embodiment, processing temperature is greater than about 850 degrees Centigrade and less than about 1000 degrees Centigrade.

The coating composition may be applied using any convenient method known to one skilled in the art. In one embodiment, the coating composition may be employed using a method comprising a spray technique, for example, powder coating method or a precursor based coating, for example sol-gel coating.

In various embodiments, the coating on corrosion prone glasses may be carried out by employing organo-metallic precursors, inorganic precursor, or by spraying metal powders followed by their melting. In one embodiment, for forming an organo-metallic precursor based coating a sol of a source for the metal oxide, a solvent and a stabilizer is prepared. The glass is then dipped in the sol and air dried at a suitable temperature to dry the sol coating. The air dried coated glass sample is then sintered at a suitable temperature to provide glass coated with metal oxide. For example, to prepare a glass with a coating of zirconia: zirconia-n-propoxide, zirconia-ethoxide, zirconia-isopropoxide, zirconia-isobutoxide or zirconia may be employed as the precursor. Solvents employed may include methanol, ethanol, butanol and iso-propanol. The glass may be coated using one or more of a spin coating, spray coating, dip coating or a brush painting technique at a temperature of about 25 degrees Centigrade. The sol-coated glass may then be sintered at about 650 degrees Centigrade for about 30 minutes to provide a glass coated with zirconia. As known to one skilled in the art, the thickness and uniformity of the coating may be measured by methods know in the art, including surface profilometry and microstructural methods. The molar quantities of the source and the solvent may be varied to obtain sols of varying density that in turn determine the thickness of the coating. In another example, to obtain a coating of yttria stabilized zirconia, yttrium nitrate may be added to the sol described above and the glass may be coated with the sol by dip coating and then drying in air. The sol coated glass may then be sintered as discussed above.

In accordance with an embodiment of the invention, an article is provided that includes a seal structure for use in an energy storage device. The article comprises a seal structure comprising a sealing glass, wherein the sealing glass joins an ion-conducting first ceramic to an electrically insulating second ceramic; wherein the ion-conducting separator has an anode surface defining an anode compartment and a cathode surface defining a cathode compartment, wherein the sealing glass has an exposed portion, wherein the exposed portion is open to one or more of the anode compartment and the cathode compartment; wherein the exposed portion of the sealing glass is coated with a coating composition, and wherein the coating composition comprises one or more of boria, alumina, titania, zirconia, yttria, and ceria.

In various embodiments, the coating composition may be employed for coating sealing glass in a variety of applications, for example high temperature rechargeable electrochemical cells and high intensity dischargeable lamps. Examples of high temperature rechargeable electrochemical cells include sodium-metal halide cells and sodium-sulfide cells. The coating composition may help to minimize or avoid the corrosions of the sealing glass that is employed in an environment that is corrosive to the sealing glass material.

### EXAMPLES

The following examples illustrate methods and embodiments in accordance with the invention, and as such should not be construed as imposing limitations upon the claims. Unless specified otherwise, all components are commercially available from common chemical suppliers such as Sigma-Aldrich (United States), and the like.

### Example 1

### Preparation of Coated Glass Resistant to Sodium

### Step A. Preparation of Glass Resistant to Halide

Silica, boria, alumina, sodium oxide and zinc oxide are blended and melted to form a homogenous composition. The oxides are melted at about 1400 degrees Centigrade. The resultant molten glass is quenched between steel plates at room temperature with the resulting solid glass being crushed to predetermined particle sizes to form a frit glass powder. The glass powder is placed between the beta-alumina tube and the insular ring and the resultant assembly heated to the processing temperature for sealing of the ceramic parts. The sealing glass composition according to this formula can be finely tuned to meet a close thermal expansion coefficient match with the ceramic parts. The amount of silica, boria, alumina, sodium oxide, zinc oxide in weight percent in the glass compositions prepared in Example 1 are provided in Table 1 below.

TABLE 1
Composition of sealing glass

| Glass Composition | Weight |
|---|---|
| Silica | 68.2 |
| Boria | 17.1 |
| Alumina | 5.3 |
| Sodium oxide | 8.4 |
| Zinc oxide | 1 |

TABLE 2

| Properties | |
|---|---|
| Coefficient of thermal Expansion | 5.6 parts per million per |
| | degrees Centigrade |
| Processing temperature | 1100 degrees Centigrade |

Step B. Coating the Glass with a Coating Composition to Render the Glass Resistant to Halide:

A sample piece of the glass prepared in Step A above was coated with zirconia using a sol-gel method. A sol containing zirconium-n-propoxide, acetic acid and iso-propanol in a molar ratio of 1:1:10 was prepared by mechanically mixing the three components. Acetic acid was used as the stabilizer and iso-propanol was used as the solvent. The glass sample was dipped in the sol maintained at a temperature of about 25 degrees Centigrade and then dried in air at the same temperature. The sol coated glass sample was then sintered at 650 degrees Centigrade for about 30 minutes in air to provide a glass uniformly coated with zirconia.

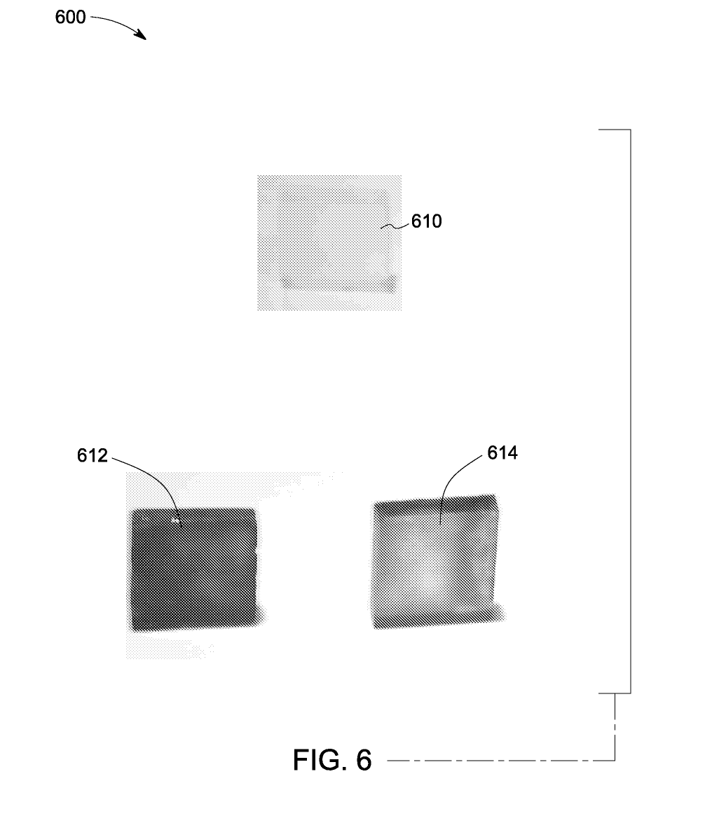

Referring to FIG. 6, a pictorial view 600 showing the effects of corrosion on coated and uncoated sealing glass is provided. An uncoated glass sample 610 was coated using a sol-gel based technique with zirconia and cured at 650 degrees Centigrade. Uniformity of the coverage of the coating on the glass was studied using scanning electron microscopy (SEM). Energy dispersive analysis of X-rays (EDAX) showed the presence of zirconia on the surface of the glass. EDAX data provided in Table 3 below shows the weight percent and atomic percent of various elements on the surface of the sealing glass composition before and after coating. Presence of zirconium in EDAX confirms the formation of zirconia coating on the surface.

TABLE 3

| Before Coating | | | After coating | | |
|---|---|---|---|---|---|
| Glass | Weight | Atomic | Glass | Weight | Atomic |
| Composition | percent | percent | Composition | percent | percent |
| Oxygen | 62.41 | 73.85 | Oxygen | 49.08 | 70.07 |
| Sodium | 4.94 | 4.07 | Sodium | 2.63 | 2.62 |
| Aluminum | 2.74 | 1.92 | Aluminum | 2.01 | 1.70 |
| Silicon | 29.92 | 20.17 | Silicon | 24.93 | 20.27 |
| | | | Zirconium | 21.35 | 5.35 |
| Total | 100.0 | | Total | 100.0 | |

### Step C: Corrosion Study:

A corrosion study was conducted using uncoated glass and glass samples coated with zirconia prepared as described above. Two sample pieces of glass were taken. One piece was left uncoated, and a second piece was coated with zirconia. Both the pieces were placed in liquid sodium, for 5 days at a temperature of about 350 degrees Centigrade. The pieces were weighed before and after the corrosion test and the weight loss in percent and weight loss per square centimeter were determined. The data is provided in Table 4.

TABLE 4

| | Weight loss in | Weight loss per |
|---|---|---|
| Glass | percentage | square centimeter |
| Uncoated glass | 20 | 0.00095 |
| Zirconia coated glass | 10 | 0.00065 |

The results provided in Table 4 and shown pictorially in FIG. 6 provide the effect of sodium corrosion results on sealing glass. Zirconia coated glass shows significant improvements in resistance to sodium corrosion. As shown in FIG. 6, the glass coated with zirconia appears relatively less darker 614 than the uncoated glass 612 indicating that uncoated glass undergoes more corrosion than the coated glass.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A seal structure, comprising:
a sealing glass joining an ion-conducting first ceramic to an electrically insulating second ceramic;
wherein the ion-conducting separator has an anode surface defining an anode compartment and a cathode surface defining a cathode compartment;
wherein the sealing glass has an exposed portion, wherein the exposed portion is open to one or more of the anode compartment and the cathode compartment;
wherein the exposed portion of the sealing glass is coated with a coating composition comprising at least one or more of boria, alumina, titania, zirconia, yttria, and ceria.

2. The seal structure of claim 1, wherein the exposed portion of the sealing glass open to the anode compartment and to the cathode compartment are coated with the coating composition.

3. The seal structure of claim 2, wherein the sealing glass comprises about 35 weight percent to about 15 weight percent of silica, about 40 weight percent to about 25 weight percent of boria, about 1 weight percent to about 10 weight percent of alumina and about 10 weight percent to about 25 weight percent of sodium oxide.

4. The seal structure of claim 3, wherein the sealing glass has a thermal expansion coefficient in a range of from about 4 parts per million per degrees Centigrade to about 8 parts per million per degrees Centigrade.

5. The seal structure of claim 3, wherein the coating composition is applied on the exposed portions open to the anode compartment and open to the cathode compartment, wherein the coating composition resists corrosion or degradation by contact with sodium or metal halides at a working temperature.

6. The seal structure of claim 3, wherein the coating composition applied to the exposed portion open to the anode compartment comprises one or more of boria, alumina, titania, and ceria.

7. The seal structure of claim 3, wherein the coating composition applied to the exposed portion of the sealing glass open to the cathode compartment comprises one or more of zirconia, yttria, alumina, titania, and ceria.

8. The seal structure of claim 1, wherein the exposed portion of the sealing glass open to the anode compartment is coated with the coating composition and the exposed portion open to the cathode compartment is left uncoated, wherein the coating composition resists corrosion or degradation by contact with sodium at a working temperature, and wherein the sealing glass resists corrosion or degradation by contact with metal halides at a working temperature.

9. The seal structure of claim 8, wherein the sealing glass comprises about 1 weight percent to about 15 weight percent of silica, about 30 weight percent to about 55 weight percent of boria, about 10 weight percent to about 25 weight percent of alumina, about 1 weight percent to about 15 weight percent calcium oxide, about 5 weight percent to about 20 weight percent of strontium oxide and about 5 weight percent to about 20 weight percent of barium oxide.

10. The seal structure of claim 8, wherein the coating composition comprises one or more of boria, titania, alumina, and ceria.

11. The seal structure of claim 1, wherein the exposed portion of the sealing glass open to the cathode compartment is coated with the coating composition and the exposed portion open to the anode compartment is left uncoated, wherein the coating composition resists corrosion or degradation by contact with metal halides at a working temperature, and wherein the sealing glass resists corrosion or degradation by contact with sodium at a working temperature.

12. The seal structure of claim 11, wherein the sealing glass comprises about 1 weight percent to about 50 weight percent to about 75 weight percent of silica, about 10 weight percent to about 20 weight percent of boria, about 5 weight percent to about 25 weight percent of alumina, and about 1 weight percent to about 5 weight percent of zinc oxide.

13. The seal structure of claim 11, wherein the coating composition comprises one or more of alumina, zirconia, yttria, titania, and ceria.

14. The seal structure of claim 1, wherein the sealing glass can seal the ion-conducting first ceramic having a first thermal expansion coefficient and the electrically insulating second ceramic having a second thermal expansion coefficient that is different from the first thermal expansion coefficient.

15. The seal structure of claim 14, wherein the thermal expansion coefficient of the sealing glass is about the same as a thermal expansion coefficient of the ion-conducting first ceramic.

16. The seal structure of claim 14, wherein the thermal expansion coefficient of the sealing glass is about the same as a thermal expansion coefficient of the electrically insulating second ceramic.

17. The seal structure of claim 1, wherein the sealing glass has a processing temperature of greater than about 850 degrees Centigrade.

18. The seal structure of claim 1, wherein the coating composition has a processing temperature greater than about 850 degrees Centigrade.

19. A process, comprising:
placing a sealing glass at the joint of an ion conducting first ceramic and an electrically insulating second ceramic, wherein the ion-conducting separator has an anode surface defining an anode compartment and a cathode surface defining a cathode compartment, wherein the sealing glass has an exposed portion, wherein the exposed portion is open to one or more of the anode compartment and the cathode compartment;
forming an assembly comprising the ion conducting first ceramic, the electrically insulating second ceramic, and the sealing glass;
heating the assembly to a processing temperature of the sealing glass;
applying a coating composition over at least one exposed portion of the sealing glass; and
sintering the assembly at a sintering temperature to form a seal structure.

20. The process of claim 19, wherein the sintering temperature is in a range of from about 400 degrees Centigrade to about 1600 degrees Centigrade.

21. The process of claim 19, wherein the processing temperature is greater than about 850 degrees Centigrade.

22. The process of claim 19, wherein the coating composition is applied using a method comprising a powder coating method or a precursor based coating.

23. An article, comprising:
a seal structure comprising a sealing glass, wherein the sealing glass joins an ion-conducting first ceramic to an electrically insulating second ceramic;
wherein the ion-conducting separator has an anode surface defining an anode compartment and a cathode surface defining a cathode compartment;
wherein the sealing glass has an exposed portion, wherein the exposed portion is open to one or more of the anode compartment and the cathode compartment; and
wherein the exposed portion of the sealing glass is coated with a coating composition comprising one or more of boria, alumina, titania, zirconia, yttria, and ceria.

24. The article of claim 23, wherein the article is a sodium-metal halide electrochemical cell.

25. The article of claim 23, wherein the article is a sodium-metal sulfide electrochemical cell.
